(19) United States
(12) Patent Application Publication
(10) Pub. No.: US 2009/0184962 A1
(43) Pub. Date: Jul. 23, 2009

(54) Systems and Methods for Managing Video Resolution in a Multiple-Output Information Handling System

(75) Inventors: Eldho V. Kuriakose, Austin, TX (US); Jaydev Muppalla Reddy, Austin, TX (US); Timothy Michael Lambert, Austin, TX (US)

Correspondence Address: BAKER BOTTS, LLP, 910 LOUISIANA, HOUSTON, TX, 77002-4995, US

(73) Assignee: DELL PRODUCT L.P., Round Rock, TX (US)

(21) Appl. No.: 12/017,707

(22) Filed: Jan. 22, 2008

(51) Int. Cl. G06T 17/00

(52) U.S. Cl. 345/428

(57) ABSTRACT

An information handling system may include a video controller, multiple video interfaces configured for connecting video devices to the video controller, and a video resolution management system. The video resolution management system may be configured to determine a lowest maximum video resolution capability for relevant video devices connected to the video controller via the video interfaces, and select a video resolution for use based at least on the determined lowest maximum video resolution capability. The video controller may be configured to transmit video signals to one or more video devices according to the video resolution selected by the video resolution management system.

### TECHNICAL FIELD

The present disclosure relates in general to information handling systems, and more particularly to systems and methods for managing video resolution in an information handling system having multiple video outputs.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some information handling systems include multiple interfaces for connecting a video device (e.g., a monitor) for viewing and/or controlling the information handling system. For example, some servers or server blades include four different interfaces for connecting a video device, including:

(1) a rear monitor connection;

(2) a front monitor connection;

(3) an Ethernet interface for remote viewing/control; and

(4) an interface for an aggregated, tiered session for viewing/control, e.g., a KVM-over-CAT5 interface.

However, connecting video devices with different display resolution capabilities to such multiple video interfaces can lead to various problems, including overdriving or under utilizing video devices. To illustrate overdriving of a video device, suppose a monitor connected to the front monitor connection of a server has a maximum video resolution capability of 1600×1200, and another monitor remotely connected to the server via the Ethernet interface has a maximum video resolution capability of 1280×1024. The video controller may set the output resolution to 1600×1200, based on the capability of the front monitor. Thus, the remote monitor is overdriven, and may show only a black screen.

As another example of overdriving, suppose a monitor connected to the front monitor connection of a server has a maximum video resolution capability of 1600×1200, and another monitor connected to the rear monitor connection of the server has maximum a video resolution capability of 1280×1024. In some systems, the front monitor may take precedence over the rear monitor, and the video controller may thus set the output resolution to 1600×1200, based on the capability of the front monitor. Thus, the rear monitor is overdriven and may show a black screen.

To illustrate under-utilization of a video device, suppose the baseboard management controller (BMC) of a server has a hardware maximum video resolution capability of 1024×768, and a monitor connected to the rear monitor connection of the server has a maximum video resolution capability of 1600×1200. The video controller may set the output resolution to 1024×768, based on the hardware capability of the BMC, regardless of whether any video devices are remotely connected to the server via the BMC. Thus, when no remote video devices are currently connected to the server, the rear monitor is under-utilized, as it is capable of displaying 1600×1200 but only receives 1024×768 signals from the video controller.

### SUMMARY

In accordance with the teachings of the present disclosure, disadvantages and problems associated with connecting video devices with different display resolution capabilities to information handling systems having multiple video interfaces have been reduced.

In accordance with one embodiment of the present disclosure, an information handling system includes a video controller, multiple video interfaces configured for connecting video devices to the video controller, and a video resolution management system. The video resolution management system may be configured to determine a lowest maximum video resolution capability for relevant video devices connected to the video controller via the video interfaces, and select a video resolution for use based at least on the determined lowest maximum video resolution capability. The video controller may be configured to transmit video signals to one or more video devices according to the video resolution selected by the video resolution management system.

In accordance with another embodiment of the present disclosure, a method for managing video resolution output from an information handling system is provided. A video resolution capability is determined for each of a plurality of video devices connected to the video controller via any of a plurality of video device connection interfaces. A lowest maximum video resolution capability of the determined video resolution capabilities is determined. A video resolution for use by the video controller is selected based at least on the determined lowest maximum video resolution capability, and the selected video resolution is communicated to a video controller such that the video controller may transmit video signals to one or more video devices according to the selected video resolution.

In accordance with another embodiment of the present disclosure, a system for managing video resolution output from an information handling system includes a controller. The controller may be configured to receive from an aggregation device a determination of a lowest maximum video resolution capability for relevant video devices connected to the aggregation device via any of a plurality of video interfaces. The controller may be further configured to determine whether a remote session for connecting to the video controller is active, and select a video resolution for use based at least on (a) the determined lowest maximum video resolution capability and (b) the determination of whether a remote session for connecting to the video controller is active. The controller may be further configured to communicate the selected video resolution to the video controller such that the video controller begins transmitting video signals to one or more video devices according to the selected video resolution.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system for managing video resolution output from an information handling system (e.g., a server blade), according to an example embodiment of the present disclosure;

FIG. 2 illustrates a more detailed view of a particular blade server of the system of FIG. 1, which is configured for managing video resolution output from the various blades of the blade server to various video devices, according to an example embodiment of the present disclosure.

FIGS. 3A-3B illustrates an example method for managing video resolution output from an information handling system to various video devices, according to an example embodiment of the present disclosure; and

FIG. 4 illustrates a decision matrix showing the determination of a video resolution for use by video controller, based on various combinations of input data representing different situations, according to an example embodiment of the present disclosure.

### DETAILED DESCRIPTION

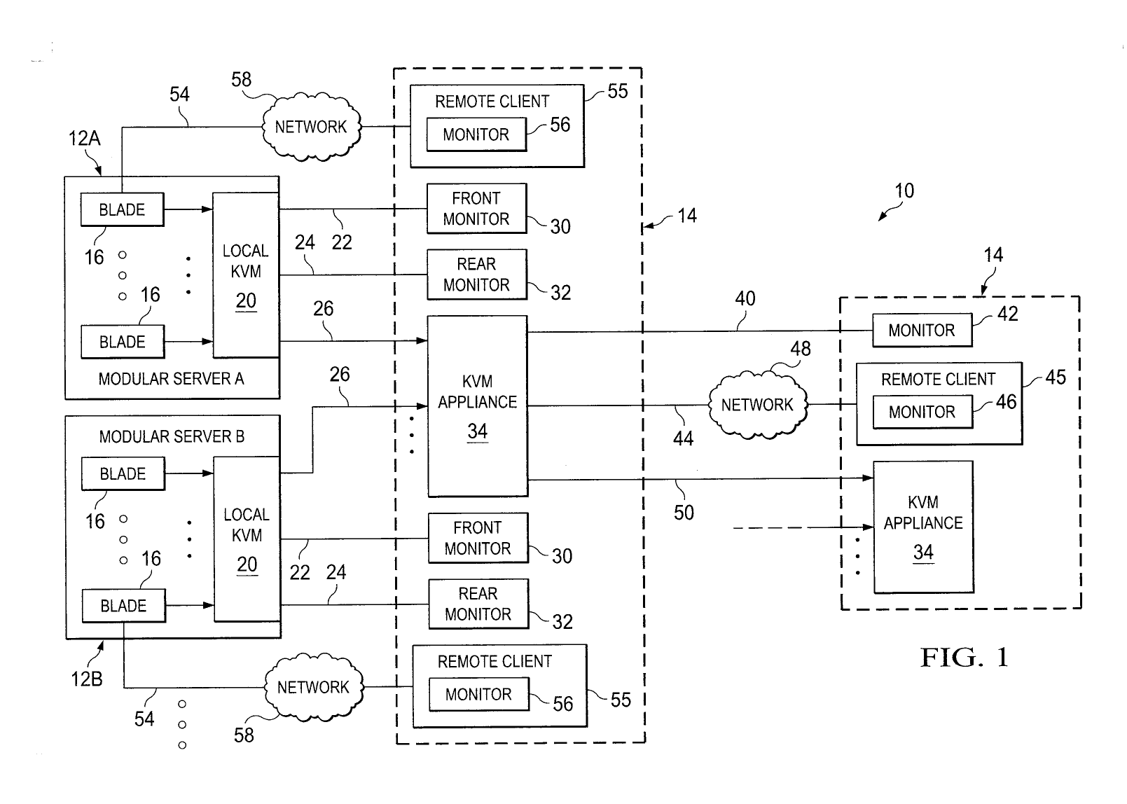

Preferred embodiments and their advantages are best understood by reference to FIGS. 1 through 4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

Also, for the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

### System Overview

FIG. 1 illustrates a system 10 for managing video resolution output from an information handling system (e.g., a blade server), according to an example embodiment of the present disclosure. System 10 includes a plurality of information handling systems 12 coupled to various video devices 14 for viewing/controlling such information handling systems 12 or components thereof. In the illustrated example, system 10 includes a plurality of modular servers 12 (12a, 12b, etc.) coupled to various video devices 14. Each modular server 12 may include any suitable number of server modules 16. For example, as shown, modular server 16 may be a blade server including any suitable number of blades 16. In one embodiment, each blade server 16 includes up to sixteen blades 16. It should be understood that modular servers 12 and server modules 16 may comprise any other type of servers or other information handling systems.

Each blade server 12 may include an aggregation device 20 providing an aggregated interface between the multiple blades 16 of that blade server 12 and one or more video devices 14. In the illustrated embodiment, aggregation devices 20 comprise local keyboard, video, and mouse (KVM) devices. Each local KVM 20 may provide one or more video connection interfaces for connecting video devices 14 to each blade 16 in that blade server 12. Thus, a single video device 14 connected to a local KVM 20 of a particular blade server 12 may be used to view and/or control any blade 16 within that blade server 12.

In the illustrated embodiment, each local KVM provides three video connection interfaces for connecting video devices 14 to blades 16, including: (1) a front monitor connection interface 22, (2) a rear monitor connection interface 24, and (3) a tiered session interface 26. Front monitor connection interface 22 may be, e.g., an interface for plugging a monitor 30 into the front of blade server 12. Similarly, rear monitor connection interface 22 may be, e.g., an interface for plugging a monitor 32 into the rear of blade server 12. Tiered session interface 26 may be, e.g., an interface for connecting to a further aggregation device 34 allowing a tiered, or hierarchical, connection of blade servers 12. For example, such aggregation device may comprise a KVM appliance 34 configured to aggregate multiple blade servers 12. As shown in FIG. 1, KVM appliance 34 may aggregate blade server 12a, blade server 12b, and additional blade servers.

KVM appliance 34 may provide one or more video connection interfaces for connecting video devices 14 to each blade server 12, such that a single video device 14 connected to KVM appliance 34 may view and/or control any blade 16 within any blade server 12 connected to KVM appliance 34.

In the illustrated embodiment, KVM appliance 34 provides three video connection interfaces for connecting video devices 14 to blades 16, including: (1) a monitor connection interface 40 for connecting a monitor 42 directly to KVM appliance 34, (2) a network connection 44 (e.g., an Ethernet or any other suitable network connection) for remotely connecting a client 45 having a monitor 46 to KVM appliance 34 via a network 48, and (3) a tiered session interface 50, which may allow even further aggregation of blade servers 12 by aggregating multiple KVM appliances 34.

Video connection interfaces (e.g., interfaces 22, 24, 26, 40, 44, and 50) may comprise any suitable wired or wireless interfaces for communicating video data between a blade server 12 and a video device 14. In embodiments including a KVM appliance 34, tiered session interface 26 may comprise, for example, a KVM-over-CAT5 interface.

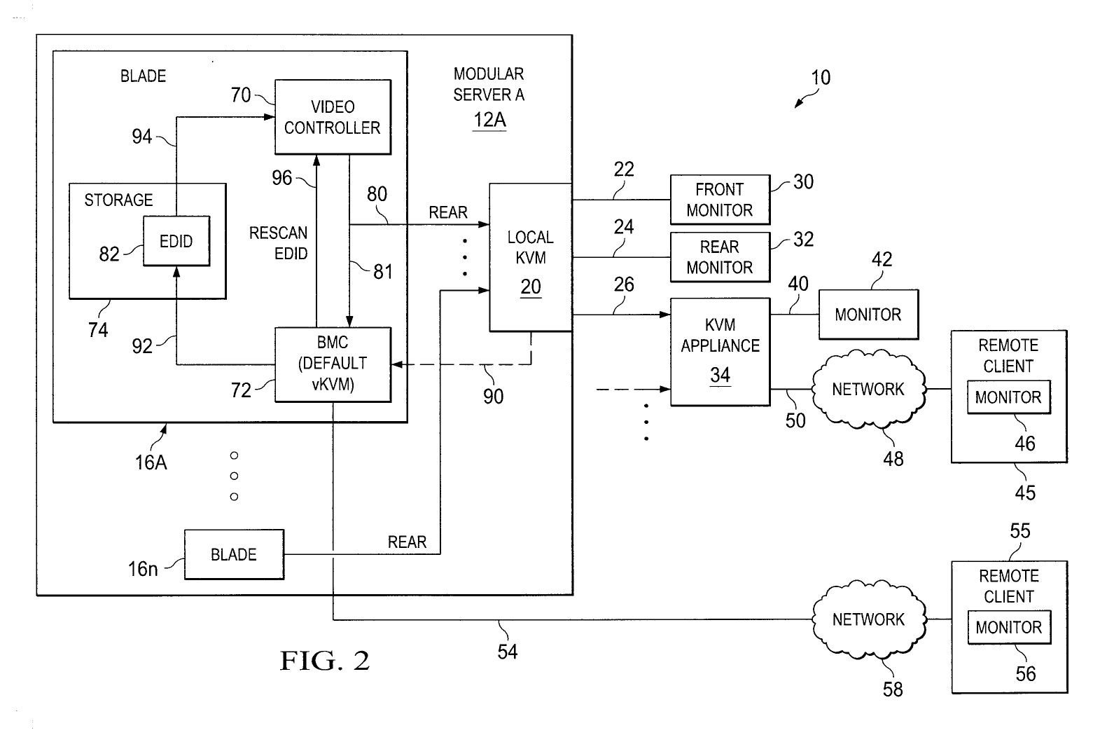

In addition to the video connection interfaces discussed above, each blade 16 may also include a remote interface 54 (e.g., Ethernet or any other suitable network connection) for remote viewing/control by one or more remote clients 55 having monitors 56 via a network 58. As shown in FIG. 1, remote interface 54 may be separate from local KVM 20. As discussed below with reference to FIG. 2, remote interface 54 may be provided by a baseboard management controller (BMC) of each blade 16.

Video devices 14 may include (a) any display device or devices operable to display video signals represented as pixels (e.g., monitors 30, 32, 42, 46, and 56), (b) aggregation devices (e.g., KVM appliances 34) for aggregating or managing the communication of video signals between a source and target device, and/or (c) any other device for managing the communication of video signals between a source and target. Display devices (e.g., monitors 30, 32, 42, 46, and/or 56) may include cathode ray tube (CRT) devices, liquid crystal displays (LCD), thin-film transistor (TFT) displays (e.g., TFT LCD displays), plasma displays, and/or any other know types of display devices.

Any “network” disclosed herein (e.g., networks 48 and 58) may include any communication system for transmitting data using wireless and/or wire-line transmissions via any storage and/or communication protocol. A network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data), or any combination thereof.

Each disclosed network may be separate, partially integrated or overlapping, or the same network. For example, networks 48 and 58 may each comprise a separate network, or may be the same network.

In general, system 10 may be configured to manage the resolution of video output from server blades 16 in order to reduce or eliminate the likelihood of video devices 14 being (a) overdriven or (b) under-utilized. For example, the video resolution output by a particular server blade 16 may be dynamically (and in some cases, automatically) modified based on input such as (a) the resolution capabilities of relevant video devices 14 currently connected to the particular blade 16, (b) whether the particular blade 16 is currently selected for viewing/control by a video device 14, and/or (c) whether there are currently any active remote sessions for viewing/controlling the particular blade 16.

### Blade Server 12A

FIG. 2 illustrates a more detailed view of blade server 12A of the system of FIG. 1, which is configured for managing video resolution output from the various blades 16 of blade server 12A to various video devices 14, according to an example embodiment of the present disclosure.

As discussed above regarding FIG. 1, blade server 12A may include a number (e.g., 16) server blades 16, indicated in FIG. 2 as blades 16A-16n, and a local KVM device 20 coupled to each blade 16A-16n. Local KVM device 20 may provide a front monitor connection interface 22 for connecting a front monitor 30, a rear monitor connection interface 24 for connecting a rear monitor 32, and a tiered session interface 26 for connecting to a KVM appliance 34.

Blade 16A (like each other blade 16 of blade server 12A) may include a video controller 70, a BMC 72, a storage device 74, and any other various hardware, software, firmware, or other computer components.

Video controller 70 may comprise any circuitry (hardware, software, and/or firmware) configured to output signals to control the display of a video device 14. For example, video controller 70 may determine the maximum video resolution, refresh rate, and number of colors that can be displayed, which the video device 14 must also be able to support. Video controller 70 may comprise any type of video controller, e.g., CGA, EGA, PGA, VGA, SVGA, XGA, MAC, etc.

In the example shown in FIG. 2, video controller 70 comprises a VGA chip the outputs analog VGA signals though an outlet connected to a rear connection interface (via path 80), a front connection interface (not shown), and BMC 72 (via path 81). In the illustrated configuration, local KVM 20 is coupled to the rear connection interface to receive signals from VGA chip 70 via rear interface path 80, and the front connection interface (not shown) is not used.

BMC 72 comprises any baseboard management controller, which may comprise a specialized microcontroller embedded on the motherboard of blade 16A. In some embodiments, BMC 72 may be configured to select a video resolution for use by video controller 70 based on (a) the resolution capabilities of one or more relevant video devices 14 currently connected to local KVM 20, (b) whether any remote monitors 56 have a currently active session through BMC 72, and/or other suitable input. As discussed below, BMC 72 may then store the selected resolution as extended display identification data (EDID) 82, which video controller 70 may use for controlling the resolution of video signals output by video controller 70.

Storage device 74 may comprise and volatile and/or non-volatile memory device(s), e.g., a hard disk, compact disk, CD-ROM, DVD, random access memory (RAM), read-only memory (ROM), electrically erasable programmable read-only memory (EEPROM), or flash memory. In the disclosed example, storage device 74 comprises an EEPROM configured to store EDID data 82 and/or other data.

As known in the art, EDID comprises information about a video device that a video controller may use to determine a resolution for video signals to send to the video device. More particularly, EDID data is a Video Electronics Standards Association (VESA) standard data format that contains basic information about a video device and its capabilities, e.g., vendor information, maximum image size, color characteristics, factory pre-set timings, frequency range limits, and character strings for the monitor name and serial number. EDID is typically stored in the video device and communicated to the video controller such that the video controller and video device can work together.

In the illustrated embodiment, EDID data 82 may comprise data that emulates or mimics actual EDID obtained from a video device 14, such that video controller 70 may use EDID data 82 in the same manner as actual EDID. As discussed below in greater detail, BMC 72 may generate and store EDID data 82 in storage device 74 based on various input data and/or algorithms performed by BMC to determine the proper EDID data 82 to be used by video controller 70 depending on the current situation. In particular, BMC 72 may generate and store EDID data 82 defining the video resolution to be output by video controller 70. In this manner, EDID data 82, and thus the video resolution output by video controller 70, may be controlled independently of the video resolution capability of any particular individual video device 14 connected to video controller 70.

In operation, when a video device 14 is connected to or disconnected from local KVM 20 of blade server 12A (or at any other suitable time), local KVM 20 may determine the lowest maximum video resolution capability of relevant video devices 14 connected to local KVM 20. As used herein, “a relevant video device 14” may be defined as a video device 14 having a maximum resolution capability that may prevent or negatively effect the display (either by the video device 14 itself or by another video device 14) of received video signals having a higher resolution than the maximum resolution capability of that video device 14.

In some embodiments, relevant video devices 14 may include any display device or aggregation device connected directly to local KVM 20. For example, in the illustrated example, relevant video devices 14 may include front monitor 30, rear monitor 32, and KVM appliance 34, each of which may or may not be connected to local KVM 20 at any time.

In some embodiments, the following video devices 14 are not “relevant video devices”: (a) monitors 46 of remote clients 45 connected to KVM appliance 34 (e.g., clients 45 connected to KVM appliance 34 via “KVM over IP”); (b) monitors 56 of clients 55 remotely connected to BMC 72 (e.g., via network 58); and (c) video devices 14 connected to KVM appliance 34 (e.g., monitors 42 and 46, and further tiered KVM appliances 34).

In some embodiments, monitors 46 and 56 of remote clients 45 and 55, respectively, may not be “relevant video devices” because such clients 45 may display signals from video controller 70 in a window (e.g., a JAVA or active-X plugin style window) such that video signals from video controller 70 of any resolution may be displayed regardless of the maximum resolution of each client's monitor 46.

In some embodiments (e.g., where KVM appliance 34 has an internal maximum resolution capability), video devices 14 connected to KVM appliance 34 (e.g., monitors 42 and 46, and further tiered KVM appliances 34) may not be “relevant video devices” because KVM appliance 34 may communicate its own internal maximum resolution capability to local KVM 20 for local KVM 20 to use in determining the lowest maximum resolution capability of connected relevant video devices, regardless of what video devices 14 are connected to KVM appliance 34 and the resolution capabilities of such video devices 14. Thus, the resolution capabilities of video devices 14 connected to KVM appliance 34 are not relevant to local KVM's 20 determination of the lowest maximum resolution capability of video devices connected local KVM 20. Therefore, video devices 14 connected to KVM appliance 34 are not “relevant video devices,” as defined herein.

For example, assume the following are connected to local KVM 20:

no front monitor 30,

1600×1200 max resolution rear monitor 32,

1280×1024 KVM appliance 34 connected directly to local KVM 20, and

1600×1200 max resolution monitor 42 connected to KVM appliance 34.

[Note: when a video device 14 is described herein by a particular resolution, the resolution indicates the maximum resolution capability of that video device 14. Thus, in this example, “1600×1200 rear monitor 32” has a maximum resolution capability of 1600×1200, and “1280×1024 KVM appliance 34” has has a maximum internal resolution capability of 1280×1024.]

In this example scenario, local KVM 20 may determine the lowest maximum video resolution capability of connected relevant video devices 14 is 1280×1024, which is controlled by KVM appliance 34 regardless of the resolution capability of monitor 42 connected to KVM appliance 34.

However, in some other embodiments, KVM appliance 34 may use a standard message passing scheme such that the KVM appliance 34 is not limited by an internal maximum resolution capability. KVM appliance 34 may be configured to determine a lowest maximum resolution capability among particular video devices 14 connected to KVM appliance 34 (e.g., monitor 42 and a further tiered KVM appliance 34), and pass such lowest resolution to local KVM's 20. In such embodiments, particular video devices 14 connected to KVM appliance 34 (e.g., monitor 42 and a further tiered KVM appliance 34) may be “relevant video devices,” and thus relevant to local KVM's 20 determination of the lowest maximum resolution capability of video devices connected local KVM 20.

After determining the lowest maximum video resolution capability of relevant video devices 14 connected to local KVM 20, local KVM 20 may pass this resolution data to BMC 72 via communication link 92, e.g., an Ethernet link.

BMC 72 may determine whether there are any current active sessions with a remote monitor 56 via BMC 72, and use this determination, along with the resolution data received from local KVM 20, as input for determining a controlling resolution to be stored as EDID data 82 and used by video controller 70. In some embodiments, BMC 72 may process an algorithm to determe the controlling resolution based on (a) the resolution data received from local KVM 20, (b) whether there are any current active sessions with a remote monitor 56, and (c) the maximum virtual KVM (vKVM) resolution capability associated with BMC 72 itself.

In some embodiments, the algorithm may determine the controlling resolution as follows:

(a) if there are no current active sessions with a remote monitor 56 via BMC 72, the controlling resolution equals the lowest maximum video resolution value received from local KVM 20; and

(b) if there are any current active sessions with a remote monitor 56 via BMC 72, the controlling resolution equals the lowest of (a) the lowest maximum video resolution of any video device 14 connected to video controller 70, and (b) the maximum virtual KVM (vKVM) resolution capability associated with BMC 72 itself (referred to herein as the “default vKVM resolution”.

After determining the controlling resolution, BMC 72 may update the EDID data 82 in storage device 74 with the controlling resolution. The update may include replacing, supplementing, or otherwise modifying EDID data 82 currently stored in storage device 74. In some embodiments, BMC 72 may not update the EDID data 82 if BMC 72 determines that the determined controlling resolution is the same as that defined by the currently stored EDID data 82.

In response to updating the EDID data 82 in storage device 74, BMC 72 may send a message to video controller 70 notifying video controller 70 to re-check, or re-scan, EDID data 82 in storage device 74. In response, video controller 70 may check or scan the updated EDID data 82 in storage device 74.

In some embodiments, video controller 70 may automatically scale up or scale down its video output resolution based on the resolution defined by the updated EDID data 82 (i.e., the controlling resoltion). In other embodiments, video controller 70 may automatically scale down its video output resolution if the updated EDID data 82 defines a lower resolution than video controller 70 is currently outputting, but may not automatically scale up its video output resolution if the updated EDID data 82 defines a higher resolution than video controller 70 is currently outputting, in case a user purposely wants to maintain the current (lower) resolution output by video controller 70. Thus, instead of automatically scaling up its video output resolution, video controller 70 (or another component of blade 16A) may provide a user interface on video device(s) 14 connected to video controller 70 (e.g., a pop-up window) allowing a user to select between (a) scaling up to the new, higher output resolution, or (b) maintaining the current, lower output resolution.

Video controller 70 may then continue outputting video signals using the updated resolution or may maintain the current resolution, depending on the user's selection.

In some embodiments, BMC 72 of blade 16A may only update EDID data 82 for blade 16A when blade 16A is selected for viewing/control by one or more video devices 14. BMC 72 of blade 16A may store the default vKVM resolution in EDID data 82 when blade 16A is not selected for viewing/control by any video devices 14, and then update the EDID data 82 as appropriate when blade 16A is selected for viewing/control.

### EXAMPLE METHOD OF OPERATION

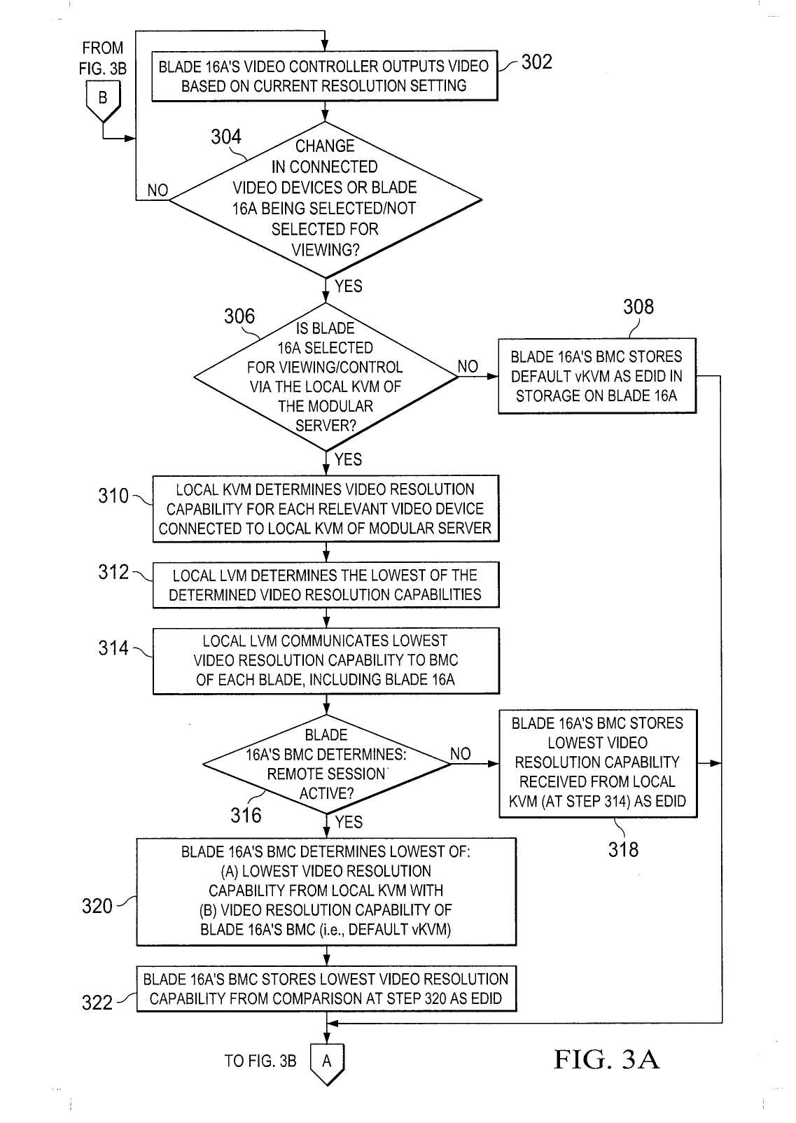

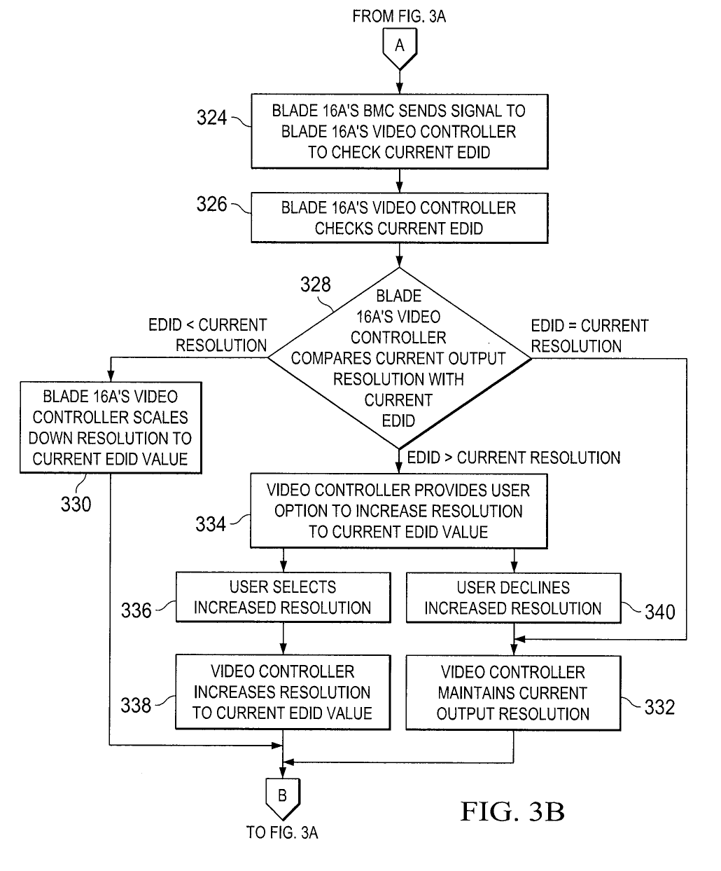

FIGS. 3A-3B illustrates an example method 300 for managing video resolution output from an information handling system to various video devices, according to an example embodiment of the present disclosure. Method 300 may be best understood with reference to FIG. 2.

According to one embodiment, method 300 preferably begins at step 302. Teachings of the present disclosure may be implemented in a variety of configurations of system 10. As such, the preferred initialization point for method 300 and the order of the steps 302-340 comprising method 300 may depend on the implementation chosen.

At step 302, video controller 70 of blade 16A (subsequently referred to as blade A) outputs video signals based on a current resolution setting. The current resolution setting may be a default setting, or may have been determined based on EDID data retrieved from storage device 74.

At step 304, if either (a) a change in the video devices 14 connected to video controller 70 is detected (e.g., a monitor 30 or 32 or KVM appliance 34 is added or removed, or a remote client 55 initiates/terminates a remote view/control session via BMC 72), or (b) a change in whether blade 16A is selected for viewing/control via local KVM 20 is detected, the method proceeds to step 306. If not, the method returns to step 302 where video controller 70 may continue to output video at the current resolution.

At step 306, BMC 72 may determine whether blade 16A is selected for viewing/control by one or more video devices 14 connected to local KVM 20. If blade 16A is not selected for viewing/control, BMC 72 of blade 16A may update or replace EDID data 82 currently stored in storage device 74 with the default vKVM resolution. The method may then proceed to step 324, where BMC 72 notifies video controller 70 to re-scan EDID data 82, and video controller 70 acts according, as discussed in detail below. Alternatively, if it is determined at step 306 that blade 16A is selected for viewing/control, the method may proceed to step 310.

At step 310, local KVM 20 may determine the maximum video resolution capability of each relevant video device 14 connected to local KVM 20, e.g., front monitor 30, rear monitor 32, and/or KVM appliance 34.

At step 312, local KVM 20 may determine the lowest of the maximum video resolution capabilities determined at step 310. At step 314, local KVM 20 may communicate the lowest maximum video resolution capability determined at step 312 to BMC 72 via communication link 92, e.g., an Ethernet link.

At step 316, BMC 72 may determine whether there are any current active view/control sessions with a remote client 55/monitor 56 via BMC 72. If there are currently no active sessions via BMC 72, BMC 72 may update or replace EDID data 82 currently stored in storage device 74 with the lowest maximum video resolution capability received from local KVM 20 at step 314. The method may then proceed to step 324, where BMC 72 notifies video controller 70 to re-scan EDID data 82, and video controller 70 acts according, as discussed in detail below.

Alternatively, if it is determined at step 316 that there are one or more active view/control sessions with a remote client 55/monitor 56 via BMC 72, at step 320 BMC 72 may determine the lower of (a) the lowest maximum video resolution capability received from local KVM 20 at step 314, and (b) the default vKVM resolution. BMC 72 may then update or replace EDID data 82 currently stored in storage device 74 with this lowest determined resolution at step 322.

At step 324, in response to updating the EDID data 82 in storage device 74, BMC 72 may send a message to video controller 70 notifying video controller 70 to re-check, or re-scan, EDID data 82 in storage device 74. In response, video controller 70 may check or scan the updated EDID data 82 in storage device 74 at step 326.

At step 328, video controller 70 may compare the resolution level defined by the EDID data 82 retrieved at step 326 with the current output resolution used by video controller 70. If the EDID resolution level is the same as the current output resolution used by video controller 70, video controller 70 may maintain the current output resolution, as indicated at step 332, and the method may return to step 302.

Alternatively, if the EDID resolution level is lower than the current output resolution used by video controller 70, video controller 70 may automatically scale down its output resolution to the EDID resolution level at step 330, and the method may return to step 302. Scaling down video controller 70's output resolution to the EDID resolution level may ensure that no video devices 14 connected to video controller 70 are overdriven.

Alternatively, if the EDID resolution level is higher than the current output resolution used by video controller 70, at step 334, video controller 70 may instead provide a user interface on video device(s) 14 connected to video controller 70 (e.g., a pop-up window) allowing a user to select between (a) scaling up the output resolution of video controller 70 to the EDID resolution level, or (b) maintaining the current, lower output resolution of video controller 70.

Thus, video controller 70 may not automatically scale up its output resolution to an EDID resolution level that is higher than video controller 70's current output resolution. This may allow a user to intentionally maintain the current (lower) resolution output by video controller 70, which a user may desire in particular situations.

If the user selects to scale up the output resolution at step 336, video controller 70 increases its output resolution to the EDID resolution level at step 338, and the method may return to step 302. Alternatively if the user selects to maintain the current output resolution at step 340, video controller 70 may maintain its current output resolution, as indicated at step 332, and the method may return to step 302.

Method 300 may be implemented using system 10 or any other system operable to implement method 300. In certain embodiments, method 300 may be implemented partially or fully in hardware, software, firmware, and/or other logic embodied in tangible computer readable media. As used in this disclosure, “tangible computer readable media” means any instrumentality, or aggregation of instrumentalities that may retain data and/or instructions for a period of time. Tangible computer readable media may include, without limitation, random access memory (RAM), read-only memory (ROM), electrically erasable programmable read-only memory (EEPROM), a PCMCIA card, flash memory, direct access storage (e.g., a hard disk drive or floppy disk), sequential access storage (e.g., a tape disk drive), compact disk, CD-ROM, DVD, and/or any suitable selection of volatile and/or non-volatile memory and/or a physical or virtual storage resource.

Thus, various functionalities discussed above may be provided by any firmware, software, and/or other logic stored in tangible computer readable media associated with any of the components of system 10. For example, system 10 may include firmware and/or software, embodied in tangible computer readable media associated with local KVM 20 and BMC 72, for performing various functions regarding determining a resolution for use by controller 70.

### EXAMPLE SCENARIOS

To further illustrate method 300, a few example scenarios are provided below.

### Example 1

No front monitor 30,

1600×1200 rear monitor 32,

No KVM appliance,

No remote client 56 active session via BMC 72,

Default VKVM resolution=1280×1024.

Result: BMC 72 identifies there are no active remote sessions, so its VKVM resolution capability is not relevant. Thus, BMC 72 stores the lowest maximum resolution capability from local KVM 20 (1600×1200) as EDID data 82.

### Example 2

Same as Example 1, but a remote client 56 begins an active session via BMC 72.

Result: BMC 72 identifies there is an active remote session, so its vKVM resolution capability are now relevant. BMC 72 determines the lower of the default vKVM resolution (1280×1024) with the lowest maximum resolution capability from local KVM 20 (1600×1200), and stores the result (1280×1024) as EDID data 82.

### Example 3

1600×1200 front monitor 30,

1280×1024 rear monitor 32,

No KVM appliance,

No remote client 56 active session via BMC 72,

Default vKVM resolution=1280×1024.

Result: BMC 72 identifies there are no active remote sessions, so its vKVM resolution capability is not relevant. Thus, BMC 72 stores the lowest maximum resolution capability from local KVM 20 (1280×1024) as EDID data 82.

### Example 4

1920×1080 front monitor 30,

1600×1200 rear monitor 32,

1024×768 KVM appliance 34 with 1600×1200 monitor 42 connected thereto,

No remote client 56 active session via BMC 72,

Default VKVM resolution=1280×1024.

Result: BMC 72 identifies there are no active remote sessions, so its VKVM resolution capability is not relevant. Thus, BMC 72 stores the lowest maximum resolution capability from local KVM 20 (i.e., KVM appliance 34's maximum internal resolution capability of 1024×768) as EDID data 82.

### Example 5

Same as Example 4, but a remote client 56 begins an active session via BMC 72.

Result: BMC 72 identifies there is an active remote session, so its vKVM resolution capability are now relevant. BMC 72 determines the lower of the default vKVM resolution (1280×1024) with the lowest maximum resolution capability from local KVM 20 (1024×768), and stores the result (1024×768) as EDID data 82.

### Example 6

Same as Example 5, except the default vKVM resolution=800×600 (instead of 1280×1024)

Result: BMC 72 identifies there is an active remote session, so its vKVM resolution capability are relevant. BMC 72 determines the lower of the default vKVM resolution (800×600) with the lowest maximum resolution capability from local KVM 20 (1024×768), and stores the result (800×600) as EDID data 82.

### EXAMPLE DECISION MATRIX

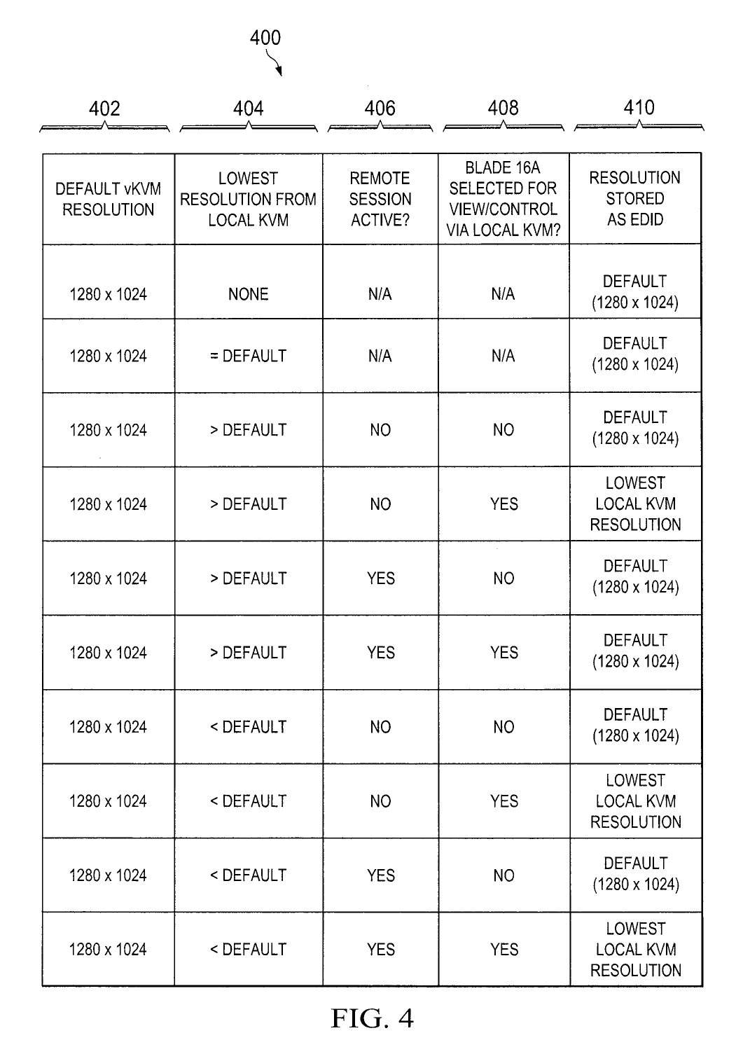

FIG. 4 illustrates a decision matrix 400 showing the determination of a video resolution to store as EDID data 82 for use by video controller 70, based on various combinations of input data representing different situations, according to an example embodiment of the present disclosure. In general, decision matrix 400 illustrates resolution determinations for a variety of different situations, each determined according to method 300 of FIGS. 3A-3B.

More particularly, columns 402, 404, 406, and 408 indicate various input data used to determine a resulting resolution, which is indicated in column 410. Each row of table 400 indicates a different situation.

Column 402 indicates an example default vKVM resolution. In this example, default vKVM resolution=1280×1024. It should be understood that this value is merely an example, and default vKVM resolution may have any other known values.

Column 404 indicates the lowest maximum resolution capability of relevant video devices 14 connected to local KVM 20 (e.g., front monitor 30, rear monitor 32, and/or KVM appliance 34), for example as determined at step 312 of method 300 (FIG. 3A). Each entry in the column indicates whether the lowest maximum resolution capability of relevant video devices 14 connected to local KVM 20 is equal to, greater than, or less than the default vKVM resolution (1280×1024) for that particular situation.

Column 406 indicates whether there are any current active sessions with a remote monitor 56 via BMC 72.

Column 408 indicates whether blade 16A is selected for viewing/control by one or more video devices 14 connected to local KVM 20.

Column 410 indicates the resulting resolution determined by BMC 72 and stored by BMC 72 as EDID data 82 for use by video controller 70, based on the input data of columns 402-408. As shown in column 10, in this embodiment, the resulting resolution in each case is either the default vKVM resolution or the lowest maximum resolution capability of relevant video devices 14 connected to local KVM 20, e.g., as determined at step 312 of method 300 (FIG. 3A).

Although the present disclosure has been described in detail, it should be understood that various changes, substitutions, and alterations can be made hereto without departing from the spirit and the scope of the invention as defined by the appended claims.

What is claimed is:

1. An information handling system, comprising:
a video controller;
multiple video interfaces configured for connecting video devices to the video controller; and
a video resolution management system configured to:
determine a lowest maximum video resolution capability for particular video devices connected to the video controller via the video interfaces; and
select a video resolution for use based at least on the determined lowest maximum video resolution capability; and
wherein the video controller is configured to transmit video signals to one or more video devices according to the video resolution selected by the video resolution management system.

2. An information handling system according to claim 1, wherein:
the video resolution management system comprises a local keyboard, video, and mouse (KVM) device; and
the information handling system comprises a modular server including multiple server modules, each coupled to the local KVM device.

3. An information handling system according to claim 1, wherein:
the video resolution management system includes a baseboard management controller (BMC), the BMC providing an interface for remotely connecting one or more video devices to the video controller, the BMC having an associated hardware maximum video resolution capability; and
wherein selecting a video resolution for use based at least on the determined lowest maximum video resolution capability includes comparing the determined lowest maximum video resolution capability with the hardware maximum video resolution capability.

4. An information handling system according to claim 1, wherein the video resolution management system is further configured to:
determine whether a remote session for connecting to the video controller is active; and
select a video resolution for use based at least on (a) the determined lowest maximum video resolution capability and (b) the determination of whether a remote session for connecting to the video controller is active.

5. An information handling system according to claim 1, wherein:
the information handling system comprises a modular server including multiple server modules, a particular server module including the video controller and a baseboard management controller (BMC);
the video resolution management system comprises a local keyboard, video, and mouse (KVM) device and the baseboard management controller (BMC) of the particular server module;
the local KVM device is configured to:
determine the lowest maximum video resolution capability for video devices connected to the video controller via the local KVM device; and
communicate the determined lowest maximum video resolution capability to the BMC of the particular server module; and
the BMC is configured to select the resolution for use based at least on a comparison of the lowest maximum video resolution capability determined by the local KVM device with a hardware maximum video resolution capability.

6. An information handling system according to claim 1, wherein the video resolution management system configured to:
store the selected video resolution for access by the video controller; and
upon an event, notify the video controller to access the stored selected video resolution.

7. An information handling system according to claim 6, wherein the selected video resolution is stored as extended display identification data (EDID) accessible by the video controller.

8. An information handling system according to claim 1, wherein the multiple video interfaces include a front monitor interface, a rear monitor interface, and an aggregation device interface for connecting to an aggregation device.

9. A method for managing video resolution output from an information handling system, the method comprising:
determining a maximum video resolution capability for each of a plurality of video devices connected to the video controller via any of a plurality of video device connection interfaces;
determining a lowest maximum video resolution capability of the determined video resolution capabilities;
selecting a video resolution for use by the video controller based at least on the determined lowest maximum video resolution capability; and
communicating the selected video resolution to a video controller such that the video controller may transmit video signals to one or more video devices according to the selected video resolution.

10. A method according to claim 9, wherein the plurality of video device connection interfaces comprises at least two of a front monitor connection interface, a rear monitor connection interface, an aggregation device interface for connecting to an aggregation device, and a network interface for connecting to a remote monitor.

11. A method according to claim 9, wherein selecting a video resolution for use by the video controller comprises selecting the determined lowest maximum video resolution capability.

12. A method according to claim 9, further comprising comparing the determined lowest maximum video resolution capability with a hardware maximum video resolution capability associated with a baseboard management controller (BMC) associated with the video controller; and
wherein selecting a video resolution for use by the video controller comprises selecting the lower of (a) the determined lowest maximum video resolution capability and (b) the hardware maximum video resolution capability.

13. A method according to claim 9, further comprising:
determining whether a remote session for connecting to the video controller is active; and
selecting the video resolution for use based at least on (a) the determined lowest maximum video resolution capability and (b) the determination of whether a remote session for connecting to the video controller is active.

14. A method according to claim 9, further comprising storing the selected video resolution in storage as extended display identification data (EDID) accessible by the video controller.

15. A method according to claim 14, further comprising, in association with storing the selected video resolution in storage as EDID data, notifying the video controller to fetch the EDID data to obtain the selected video resolution for implementation by the video controller.

16. A system for managing video resolution output from an information handling system, comprising:
a controller configured to:
receive from an aggregation device a determination of a lowest maximum video resolution capability for relevant video devices connected to the aggregation device via any of a plurality of video interfaces;
determine whether a remote session for connecting to the video controller is active;
select a video resolution for use based at least on (a) the determined lowest maximum video resolution capability and (b) the determination of whether a remote session for connecting to the video controller is active; and
communicate the selected video resolution to the video controller such that the video controller begins transmitting video signals to one or more video devices according to the selected video resolution.

17. A system according to claim 16, wherein the controller is further configured to:
compare the determined lowest maximum video resolution capability with a hardware maximum video resolution capability associated with the controller; and
select the video resolution for use based at least on (a) the results of the comparison and (b) the determination of whether a remote session for connecting to the video controller is active.

18. A system according to claim 16, wherein:
the controller comprises a baseboard management controller (BMC) of a blade of a multi-blade server; and
the aggregation device comprises a local KVM coupled to each blade of the multi-blade server.

19. A system according to claim 16, further comprising storing the selected video resolution in storage as extended display identification data (EDID) accessible by the video controller.

20. A system according to claim 16, further comprising, in association with storing the selected video resolution in storage as EDID data, notifying the video controller to fetch the EDID data to obtain the selected video resolution for implementation by the video controller.
